(19) United States
(12) Patent Application Publication
(10) Pub. No.: US 2007/0191553 A1
(43) Pub. Date: Aug. 16, 2007

(54) Silicone adhesion modulator system and use thereof for the preparation of curable anti-adhesive compositions

(75) Inventors: Didier Dhaler, Tassin (FR); John White, Chessy Les Mines (FR)

Correspondence Address: Buchanan Ingersoll & Rooney PC, P.O. Box 1404, Alexandria, VA, 22313-1404, US

(73) Assignee: RHODIA CHIMIE, AUBERVILLIERS (FR)

(21) Appl. No.: 11/655,125

(22) Filed: Jan. 19, 2007

Related U.S. Application Data
(63) Continuation of application No. 10/478,868, filed on May 27, 2004, now abandoned.

(30) Foreign Application Priority Data
Jun. 7, 2001 (FR) 0107477

(51) Int. Cl. C08L 83/04; B32B 27/00

(52) U.S. Cl. 525/477

(57) ABSTRACT

A release regulating silicone composition, and its use for preparing curable release compositions (Si—H/Si-Vi), adapted to be applied on substrates to facilitate removal of adhesive materials reversibly glued on said substrates are provided. The release regulating system can be based on: 96 to 85 parts by weight of at least a reactive polyorganosiloxane resin (A) of the type: MDViQ, MDViT, MMHexenylQ, or MMAllyloxypropylQ; 4 to 15 parts by weight of at least a non-reactive resin (B) of the type: MD′Q, MDD′Q, MDT′, MQ or MDQ. The regulating system can be used to prepare release compositions including a linear polyorganosiloxane, said regulating system, a hydrosilylation inhibitor, a linear crosslinking polyorganohalogenosiloxane and a hydrosilylation catalyst.

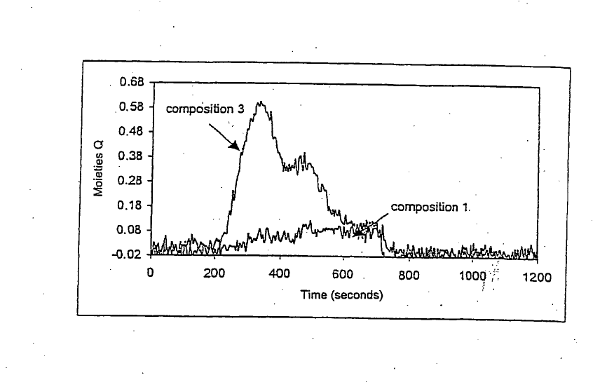

The object of the invention is a novel silicone adhesion modulator system and the use thereof for the preparation of anti-adhesive silicone compositions, curable and applicable onto substrates, in such a manner as to facilitate the removal of adhesive materials reversibly laminated onto these substrates.

The use of solutions of polymethylvinylsiloxane resins in a vinyl-containing silicone oil with the addition of a methylhydrogenpolysiloxane crosslinker soluble in the resin solutions, of an inhibitor and of an addition reaction catalyst, for coating substrates such as paper, or thin aluminum foils, etc. in order to allow the controlled detachment of pressure-sensitive adhesive materials (“pressure-sensitive adhesive: PSA”), such as acrylic adhesives, from said substrates is known (French Patent No. 2,450,642). This type of composition has the disadvantage that it is of only moderate efficacy in relation to other adhesives, in particular those of the styrene-butadiene rubber type.

It has also been proposed (U.S. Pat. No. 3,722,247) to treat the paper substrates using compositions containing polyorganohydrogensiloxane resins as adhesion modulators, to allow the controlled detachment of rubber-based adhesives. Such compositions have low performance in relation to acrylic adhesives.

The European patent application EP-A-0,601,938 discloses an adhesion modulator system comprising a mixture based on:
a 50% by weight solution in xylene of a polymethylvinylsiloxane resin A containing:
   36 mol % of moieties (M) Me₃SiO_{1/2}
   6 mol % of moieties (D^{Vi}) Me^{Vi}SiO
   58 mol % of moieties (Q) SiO₂
a 30% by weight solution in toluene of a polymethylhydrogensiloxane resin B containing:
   39 mol % of moieties (M) Me₃SiO_{1/2}
   3.5 mol % of moieties (D′) MeHSiO
   56.5 mol % of moieties (Q) SiO₂

in proportions corresponding to an A/B weight ratio of 50/50 as dry products (both resins being in solid form in the dry state);
polydimethylvinylsiloxane oil C exhibiting a viscosity of 200 mPa.sec at 25° C. and containing 1 mol % of SiVi functions in the form of Me₂ViSiO_{1/2} and MeViSiO moieties, C being in a quantity such that the weight ratio A+B/C corresponds to 45/55 as dry products;
0.15 part by weight of ethynylcyclohexanol (crosslinking inhibitor) per 100 parts by weight of silicone polymers;
the xylene and the toluene being eliminated under vacuum at 100° C.

The modulator thus constituted has a viscosity of the order of 4000 mPa.sec at 25° C.

Although this modulator already constitutes an advance compared to the existing one, it nonetheless remains open to improvement namely by increasing the modulating power, without however reducing the instantaneous adhesion with no pressure—the “tack”—of the adhesive coating. This point is particularly crucial in certain applications of silicone anti-adhesives, such as for example for adhesive labels for bottles, which must be suited to the present extremely high speeds of bottling lines.

The modulating power is comparable to the ability to increase the force of detachment of the anti-adhesive silicone film in relation to that of the adhesive coating to which it is attached.

That being the state of the technology, one of the essential objectives of the present invention is to propose a novel adhesion modulator system for anti-adhesive, crosslinkable (especially by Si—H/SiVi polyaddition) silicone compositions, which system must be an improvement on the modulator according to EP-A-0,601,938.

Another essential objective of the invention is to provide a new silicone adhesion modulator system capable of being used for the preparation of curable (especially by Si—H/SiVi polyaddition) compositions, and having a high modulating power, without prejudice to the “tack” of the adhesive.

Another essential objective of the invention is to provide a new silicone adhesion modulator system capable of being used for the preparation of curable (especially by Si—H/SiVi polyaddition) compositions, constituting an effective tool for the formulator of anti-adhesive films, in other words allowing him to regulate, over a wide range, the force of detachment of the anti-adhesion films, for a varied and extended spectrum of substrates and adhesives.

Another essential objective of the invention is to provide a new silicone adhesion modulator system capable of being used for the preparation of curable (especially by Si—H/SiVi polyaddition) compositions, allowing the controlled detachment of all types of adhesive, acrylic or rubber, and from various substrates (paper, glass, plastic material, metal, etc.)

Another essential objective of the invention is to provide a new silicone adhesion modulator system capable of being used for the preparation of curable (especially by Si—H/SiVi polyaddition) compositions, this modulator making it possible for the complex (laminate) formed by the substrate coated with the cured silicone composition and the adhesive system to exhibit excellent stability as regards its adhesion performance over time (“stability of release performance”).

Another essential objective of the invention is to provide a novel silicone adhesion modulator system capable of being used for the preparation of curable (especially by Si—H/SiVi polyaddition) compositions, this modulator being simple to prepare and to use, and economical.

Another essential objective of the invention is to provide anti-adhesive, crosslinkable (especially by Si—H/SiVi polyaddition) silicone compositions, comprising a novel adhesion modulator system of high modulating power, with no effect on the “tack” of the adhesive, nor on the other adhesion properties, which compositions must be of low cost, easy to apply to all types of substrate, and crosslinked in anti-adhesive, cohesive and effective films.

These objectives, among others, are achieved by the invention, which first of all concerns an adhesion modulator system based on:
(A) at least one polyorganosiloxane resin existing in solid form in the dry state, and consisting of at least two different types of siloxy moiety R₃SiO_{1/2} (moiety M) and SiO₂ (moiety Q) and/or RSiO_{3/2} (moiety T), and possibly moieties R₂SiO (moiety D), the radicals R being identical or different and representing organic radicals, with a number of moieties (M)/number of moieties (Q) and/or (T) ratio of 0.6-1, the number of moieties (D) that may be present being 0.5-10 per 100 mol of resin;
(B) at least one polyorganosiloxane resin existing in solid form in the dry state, and consisting of at least two different types of siloxy moiety R′₃SiO_{1/2} (moiety. M) and SiO₂ (moiety Q) and/or R′SiO_{3/2} (moiety T), and possibly moieties R′₂SiO (moiety D), the radicals R′ being similar or different and representing organic radicals, with a number of moieties (M)/number of moieties (Q) and/or (T) ratio of 0.6-1, the number of moieties (D) that may be present being 0.5-10 per 100 mol of resin;
(C) at least one solvent or at least one diluent of the mixture of resins (A) and (B);
   characterized in that:
the resin (A) is reactive and represents a quantity, in parts by weight, of 99 to 75, preferably 97 to 80, and still more preferably 96 to 85;
the resin (B) is nonreactive and represents a quantity in parts by weight, of 1 to 25, preferably 3 to 20 and still more preferably 4 to 15 parts by weight.

These modulators are very effective in terms of modulating power and very reactive. They do not affect the performance of the adhesive and in particular do not impair its “tack”. They are of low cost and are suitable for all types of substrate and adhesive.

It is to the inventors' credit that they understood the importance of the nonreactive species B of resins of the type “MQ”, in the search for an improved and effective modulator. Moreover, the inventors were able to proceed to the judicious and advantageous selection of the correct proportions between the nonreactive species B of resins of the type “MQ” and the reactive species A of resins MQ.

This concept of nonreactive silicone resin B of the type “MQ” is fundamental in the context of the invention. Thus, a silicone resin which does not contain functions capable of allowing it to bind with the other species of resins present and thus to integrate the crosslinking network is described as “nonreactive”. The resins B are thus not incorporated into the crosslinking network by covalent chemical bonds. Hence they can be extracted from the network by entrainment with an appropriate solvent.

From which it follows that the resins B can also be described by the term “extractable”. The extractable or nonextractable nature of a silicone resin of the type “MQ” is determined by means of a test, performed on the crosslinked coating derived from a silicone composition including the modulator. This test is performed either immediately after crosslinking (“in-line”) or a few days afterwards (“off-line”). This test consists in immersing the silicone coating in toluene to extract all the silicone species not integrated into the silicone network. The extracted silicone is then estimated in solution in the toluene, by atomic adsorption.

For the purposes of the invention, the term “MQ resin”, taken in the manner in which it is generally accepted, denotes any resin B exclusively or in particular siloxylated moieties “M=R₃SiO_{1/2}” and “Q=SiO₂”.

For the purposes of the invention, a resin B is considered as nonreactive or extractable from the time when:
the quantity of B is greater than or equal to 50% by weight relative to the mass of B initially introduced,
and B is found in the total extractables.

In the modulator system according to the invention, the formulators of anti-adhesive, crosslinkable (especially by Si—H/SiVi polyaddition) silicone compositions have available a reliable and effective tool for regulating the force of detachment.

The nature of the radicals R and R′ in the resins A and B is selected in such a manner as to render them respectively reactive and nonreactive.

In the preferred mode of implementation of the invention, which relates to modulators for silicone compositions crosslinkable by polyaddition, e.g. POS Si-alkenyl (for example Vi=vinyl) and POS Si—H—, the modulator system is characterized in that:
in the resin (A), the radicals R independently and at least partially represent:
   alkyl—preferably C₁-C₁₈—, or (cyclo)alkyl—preferably C₃-C₁₈— groups,
   (cyclo)alkyl—preferably C₃-C₁₈— groups
   C₂-C₂₀, preferably C₂-C₁₂, alkenyl groups,
   C₃-C₂₀, preferably C₄-C₁₂, (cyclo)alkenyl groups,
   or (C₃-C₉)alkenyloxy(C₂-C₄)alkylene groups,
preferably at least 80 mol % of the radicals R representing a methyl group,
at least 0.1 mol %, preferably from 0.5 to 5 mol % of the radicals R representing an alkenyl or alkenyloxyalkylene group bound to silicon (“Si-alkenyl”), the vinyl radical (Vi) being particularly preferred as R=alkenyl;
in the resin (B), the radicals R′ independently and at least partially represent:
   hydrogen,
   alkyl—preferably C₁-C₁₈—, or (cyclo)alkyl—preferably C₃-C₁₈— groups,
   or (cyclo)alkyl groups—preferably C₃-C₁₈—,
preferably at least 80 mol % of the radicals R′ representing a methyl group;
the resin (A) containing less than 2.5 (preferably less than 0.5) mol % of silanol functions;
the resin (B) containing less than 10 (preferably less than 2.5) mol % of silanol functions.

Thus, the resins (A) are preferably resins with “Si-alkenyl” functions, especially vinyl group containing resins, which are well-known to a person skilled in the art. In these resins (A), the groups R=alkenyl or alkenyloxy can be situated on the moieties (M), (D) or (T). These resins (A) can be prepared for example according to the process described in the U.S. Pat. No. 2,676,182.

The proportion of silanol groups in these resins can be controlled by means of a treatment well known to a person skilled in the art. This treatment makes use of a silazane, which makes it possible to lower the proportion of residual silanol functions to less than 0.3% by weight.

A certain number of these resins are commercially available, most often in the form of solutions, for example 40-70%, in a solvent such as toluene or xylene.

In this preferred mode of implementation of the invention, the reactive resin (A) is a resin which contains Si-Vi moieties and which is selected from the group comprising:
MD^{Vi}Q where the vinyl groups are included in the moieties (D),
MD^{Vi}TQ where the vinyl groups are included in the moieties (D),
MM^{Vi}Q where the vinyl groups are included in part of the moieties (M),
MM^{Vi}TQ where the vinyl groups are included in part of the moieties (M),
MD^{Vi}T where the vinyl groups are included in the moieties (D),
MM^{hexenyl}Q (possibly containing moieties T bearing or not bearing an alkenyl group) where the hexenyl groups are included in part of the moieties (M),
MM^{allyloxypropyl}Q (possibly containing moieties T bearing or not bearing an alkenyl group) where the allyloxypropyl groups are included in part of the moieties (M),
all combinations of each of the aforesaid resins with moieties M^{OH} and/or D^{OH} and/or T^{OH},
and mixtures thereof.

The resin (B) is a nonreactive resin, which can nonetheless contain with functions meeting the same definition as those that are reactive in the resin (A) and/or in the constituents of the silicone composition including the modulator, whereas these functions are not reactive in the resins (B).

In particular, the resins (B) can be MQ resins, possibly containing nonreactive “Si—H” and/or “Si—OH” functions. These resins (B) with “Si—H” functions can in particular be those described in the U.S. Pat. No. 3,772,247, wherein the nonreactive hydrogen atoms are situated in the chain; a certain number of these resins are commercially available.

In this preferred mode of implementation of the invention, the adhesion modulator system is characterized in that the nonreactive resin (B) is selected from the group comprising:
MD′Q where the hydrogen atoms bonded to silicon are included in the moieties (D),
MD′TQ where the hydrogen atoms bonded to silicon are included in the moieties (D),
MDD′Q where the hydrogen atoms bonded to silicon are included in the moieties (D),
MDD′TQ where the hydrogen atoms bonded to silicon are included in the moieties (D),
MDT′ where the hydrogen atoms bonded to silicon are included in the moieties (T),
MDD′T′ where the hydrogen atoms bonded to silicon are included in the moieties (T) and (D),
MDD′TT′ where the hydrogen atoms bonded to silicon are included in the moieties (T) and (D),
MQ,
MDQ,
MDTQ,
all combinations of each of the aforesaid resins with moieties M^{OH} and/or D^{OH} and/or T^{OH},
and mixtures thereof.

As indicated above, the resins (B), and to a lesser extent the resins (A), can contain silanol groups carried by the moieties M and/or D and/or T. The OH of the silanols can be residual OH from the synthesis of the MQ resins.

As solvents or diluents (C) for these solid resins, the following may be used:
(1) standard hydrocarbon solvents for silicone resins, solvents of the aromatic (xylene, toluene, etc.) or saturated aliphatic (hexane, heptane, white spirit, tetrahydrofuran, diethyl ether, etc.) type, chlorinated solvents (methylene chloride, perchloroethylene, etc.).
They are generally used in a quantity corresponding to 50-70 parts by weight per 30-50 parts by weight of solid resins (A)+(B).
(2) solvents described as “reactive” such as:
   (a) liquid polyorganosiloxane resins, whereof the organic radicals are C₁-C₁₈ alkyl or cycloalkyl groups, C₂-C₂₀, preferably C₂-C₁₂, alkenyl groups, exhibiting a number of moieties (M)/number of moieties (Q) and/or (T) ratio of the order of 1 to 4 and possibly from 1 to 5 moieties (D) per 100 mol of liquid resin, and containing from 0.5 to 5 mol % of alkenyl functions bonded to silicon (“Si alkenyl”) or atoms of hydrogen bonded to silicon (“SiH”), these resins exhibiting a viscosity at 25° C. of less than 100 mPa.sec, preferably of the order of 2 to 50 mPa.sec.
   These liquid resins are known products; in particular, they are described in U.S. Pat. No. 4,707,531 and the European application EP-A-389,138.
   and/or (b) liquid polyorganosiloxane oils, whereof the organic radicals are C₁-C₁₈ alkyl or cycloalkyl groups, C₂-C₂₀ alkenyl, (C₃-C₉)alkenyloxy(C₂-C₄)alkylene, oils containing from 0.2 to 5 mol % of alkenyl or alkenyloxyalkylene groups bonded to silicon, as chain end(s) or within the chain, said oils exhibiting a viscosity of less than 200 mPa.sec.
   and/or (b′) liquid polyorganosiloxane oils, bearing hydrogen substitutents and whereof the organic radicals are C₁-C₁₈ alkyl or cycloalkyl groups, C₂-C₂₀ alkenyl, (C₃-C₉) alkenyloxy(C₂-C₄)alkylene, oils containing from 0.2 to 5 mol % of hydrogen substitutents bonded to silicon, as chain end(s) or within the chain, said oils exhibiting a viscosity of less than 200 mPa.sec.
   and/or (c) hydrocarbons with one or more olefinically unsatured groups(s) such as C₁₄-C₁₈ olefins, dibutyl maleate, decyl vinyl ether, dodecyl vinyl ether, camphene, meta-bis-isopropenylbenzene, etc.
   The solvents described as “reactive” are generally used in a quantity corresponding to 20-50 parts by weight per 80-50 parts by weight of solid resins (A)+(B);
(3) aqueous emulsions of nonionic surfactants (polyvinyl alcohol, polyethoxylated alkylphenols, ethoxylated ethers of fatty alcohols, etc.) generally containing of the order of 1-3% by weight of surfactant.
They are generally used in a proportion of 40-70 parts by weight per 60-30 parts by weight of solid resins (A)+(B).

The adhesion modulator system of the invention can therefore in particular be in the solution or emulsion form. It can be obtained by mixing of the constituents (A), (B) and (C), depending on the case:
until dissolution or dilution of the solid resins (A) and (B) in the solvent or diluent (C): (1) and (2),
until emulsification of the solid resins (A) and (B) in the solvent or diluent (C): (3).

Also an object of the present invention are the curable, anti-adhesive silicone compositions containing the modulator system according to the invention. These compositions are preferably of the type crosslinkable by polyaddition (Si-alkenyl, e.g. Vi/Si—H).

Thus, in the preferred mode of application of the invention, compositions are targeted which are curable by polyaddition and anti-adhesive and contain:
at least one (preferably 100-x parts by weight) linear polydiorganosiloxane (D) blocked by terminal triorganosiloxane groups, said organic radicals being C₁-C₁₈ alkyl or cycloalkyl groups, C₂-C₂₀, preferably C₂-C₁₂, alkenyl, (C₃-C₉)alkenyloxy(C₂-C₄)alkylene, at least 80 mol % of said radicals being a methyl group, at least 0.1 mol %, preferably from 0.5 to 5 mol. % of said organic radicals being identical or different alkenyl or alkenyloxyalkylene groups directly bonded to silicon (“Si alkenyl”);
at least one (preferably x parts by weight of) modulator system based on the constituents (A), (B) and (C) as defined above, wherein the value of x can range from 0.1 to 100, preferably from 5 to 95 and quite particularly from 10 to 90;
at least one hydrosilylation inhibiting agent;
at least one linear polyorganohydrogensiloxane crosslinking agent (E) containing from 1.6 to 0.5 mol % of hydrogen atoms directly bonded to silicon (“SiH”) as chain end(s) and/or within the chain, the identical or different organic radicals being C₁-C₁₈ alkyl groups, at least 80 mol % of said organic radicals being methyl groups, the quantity of crosslinking agent being such that the (number of moles of “SiH” deriving from the nonreactive resin (B), from the “reactive” solvent (C) and from the crosslinking agent (E))/(number of moles of “Si alkenyl” deriving from the reactive resin (A), from the “reactive” solvent (C) and from the linear blocked polydiorganosiloxane (D)) ratio is greater than 1, preferably of the order of 1.1 to 2.5;
an effective quantity of a hydrosilylation catalyst.

The Linear Blocked Polydiorganosiloxane with “Si alkenyl” functions (D) exhibits a viscosity of at least 50 mPa.sec, generally of the order of 10.0 to 1000 mPa.sec; it can contain traces of nonlinear siloxane moieties (T) and/or (Q).

The vinyl group containing oils are commercial products commonly used for preparing curable anti-adhesive compositions (U.S. Pat. No. 4,623,700).

The oils with heavier alkenyl groups or alkenyloxyalkylene groups are in particular described in the patents EP-B-0,219,720 and EP-A-0,454,130.

The crosslinking agent with “Si—H” functions (E) exhibits a viscosity lower than 200 mPa.sec, preferably of the order of 5 to 150 mPa.sec. Examples of these crosslinking agents are given in the U.S. Pat. No. 4,623,700 and the European patent EP-B-0,219,720.

Among the catalysts that can be present, the well known derivatives and complexes of metals such as platinum, rhodium, ruthenium, etc. may be cited. Examples of catalysts are given in the U.S. Pat. Nos. 3,159,601, 3,159,662, 3,220,972, 3,715,334, 3,775,452, 3,814,730, 3,296,291 and 3,928,629; and French patents FR-A-1,313,846 and 1,480,409. They are generally used in a quantity of the order of 5 to 500 parts by weight expressed as metal per million parts by weight of reactive silicone polymers.

The hydrosilylation inhibiting agent is present in a quantity such that it inhibits the action of the catalyst at ambient temperature, this inhibitory action ceasing during the crosslinking treatment at high temperature; this quantity is generally of the order of 0.01 to 1 part by weight. In particular, in the case where the hydrosilylation inhibitor is ethynylcyclohexanol, it is present in a ratio of 0.1 to 0.25 parts by weight per total 100 parts by weight of silicone.

Among the inhibitors, the dialkyl dicarboxylates (U.S. Pat. Nos. 4,256,870 and 4,476,166), the dialkyl acetylenedicarboxylates (U.S. Pat. No. 4,347,346), the acetylenic alcohols (U.S. Pat. Nos. 3,989,866, 4,336,364 and 3,445,420), etc. can be cited.

According to a preferred characteristic of the invention, the concentration of [POS (B)], in % dry weight relative to the total mass of the composition is defined as follows:
[POS (B)]≦20
preferably [POS (B)]≦15
and still more preferably [POS (B)]≦10.

It has in fact been possible to observe, in the context of the invention, that the performance of the modulator system is optimized in that care is taken to introduce it into the anti-adhesive silicone composition in a quantity such that B does not represent more than 20% dry weight, relative to the total mass of the composition.

According to one option, the modulator systems and the anti-adhesive silicone compositions that contain them are not organic solutions, but emulsions. In this case, as indicated above, the compound (C) (3) contains water and nonionic surfactants (polyvinyl alcohol, polyethoxylated alkylphenols, ethoxylated ethers of fatty alcohols, etc.). The modulator system in emulsion generally contains of the order of 1-3% by weight of surfactant.

Said curable compositions are fluid at normal temperature; their viscosity is generally of the order of 50 to 500 mPa.sec at 25° C.

They can be applied by means of devices used on industrial machines for coating paper such as five-roll coating head, air knife-systems, equalizing bar systems, etc. on substrates of flexible material, then cured by passing through tunnel ovens heated to 70-200° C.; the passage time in these ovens is dependent on the temperature; it is generally of the order of 5 to 15 seconds at a temperature of the order of 100° C. and of the order of 1.5 to 3 seconds at a temperature of the order of 180° C.

Said compositions can be deposited on any flexible material or substrate such as papers of various types (supercalendered, coated, etc.), boards, cellulose foils, metal foils, plastic (polyester, polyethylene, polypropylene, etc.) films, etc.

The quantities of the compositions deposited are of the order of 0.5 to 2 g per m² of surface to be treated, which corresponds to the deposition of layers of the order of 0.5 to 2 μm.

The materials or substrates thus coated can subsequently be placed in contact with any rubber, acrylic or other, pressure-sensitive adhesive materials. The adhesive material is then easily detachable from said substrate or material.

The following examples are given for illustration and cannot be considered as a limitation of the scope and of the spirit of the invention.

### EXAMPLES

### Example 1

I. Products Used

A1 MM^{Vi}Q resin purchased from Archimica ref. MQV6
B1 Rhodia® resin of MD′Q structure containing 39 mole ù of moieties M (Me3SiO½), 3.5 mol % of moieties D′ (MeHSiO) and 56.5 mol % of moieties Q (SiO2)
Diluent C1: PDMS vinyl group containing oil with alpha and omega vinyl functions (2.8 mol meq/100 g) having a viscosity of 60,000 cps at 25° C.
Diluent C2 (tetradecene).
These resins are formulated as modulators as described in Table 1 below. 3 modulators were formulated, the first containing only the resin A1=MM^{Vi}Q, the second with the replacement of 5% of A1=MM^{Vi}Q with B1=MD′Q and the last with 10% of B1=MD′Q. This resin B1=MD′Q is nonreactive.

II. Formulation of Modulators.

TABLE 1

| | FORMULA- | FORMULA- | FORMULA- |
|---|---|---|---|
| | TION-1 | TION-2 | TION-3 |
| A1 (dry) | 66.5 | 63.1 | 59.7 |
| B1 (dry) | 0 | 3.4 | 6.8 |
| C1 | 13.5 | 13.5 | 13.5 |
| C2 | 20 | 20 | 20 |
| Ethynylcyclo- | 0.15 | 0.15 | 0.15 |
| hexanol (ECH) | | | |
| Viscosity | 1500 | 1800 | 1800 |
| mPa · sec | | | |
| at 25° C. | | | |

These modulators were then incorporated in a standard solvent-free thermal formulation, then coated on a Rotomec-brand pilot coating plant. This pilot plant includes a coater with a 5-roll coating head, and a crosslinking oven.

III. Silicone Anti-Adhesive Coating Compositions

TABLE 2

| COMPOSITIONS | 1 | 2 | 3 |
|---|---|---|---|
| Vinyl group | 40 | 40 | 40 |
| containing oil D | | | |
| Crosslinker E | 8.4 | 8.1 | 7.8 |
| FORMULATION-1 | 60 | | |
| FORMULATION-2 | | 60 | |
| FORMULATION-3 | | | 60 |
| Catalyst | 6.8 | 6.8 | 6.8 |
| % MD′Q in the | 0% | 2% | 4% |
| composition | | | |

vinyl group containing oil D: α,ω-vinyl group containing PDMS oil with 0.022 mol/100 g of Vi. This oil contains 0.15% of ECH inhibitor.
crosslinker E: a hydrogenated mixture of PDMS oils commonly described as crosslinker of structure MD′DM, containing 1.33% of hydrogen and having a viscosity of 30 cps.
a catalyst of Karstedt Pt containing 2000 ppm of Pt.
   IV. Operating Conditions on the Rotomec Pilot Plant:
   Speed: 100 m/min
   Oven: 150° C. to have 128° C. on the paper substrate.
   Deposition density: 1.25-1.35 g/m²
   Substrate: Ahlstrom glassine 9564 (yellow).
   V. Tests Used:
Weight of the silicone coating: the silicon atoms in the coating are excited using a radioactive source or a fluo X tube and the X intensity reemitted by the coating is measured. By means of a calibration, the weight of the silicone coating is thus determined. The equipment used has the reference number Lab X1000, marketed by the company Oxford.
Proportion of extractables (on exit from the coater: “in-line”/4 days after the crosslinking: “off-line”): the test consists in immersing the coating in toluene then estimating the siloxyl moieties Q (i.e. the “MQ” resin) that have been transferred in the solvent by gas chromatography (GC) with filtration by infrared (IR) spectroscopy. By means of a calibration, the proportion of silicone extractable from the coating is obtained. Two measurements can be made, either on a coating on exit from the coater (“in-line”), or on a coating that has been stored for 4 days at 23° C./50% relative humidity (“off-line” application).
Crosslinking: the polymerization level of the coating on exit from the coater is described by a certain number of specialist tests: “smear”, where the oily character of the surface is described and “rub off”, which characterizes the attachment to the substrate.
Force of detachment: the test used corresponds to the Finat Standards No. 3 and 10, Issue 5 of 1999. This test is performed 4 days after the crosslinking (“off-line”) with adhesive tapes marketed under the brand name Tesa® 7475 at 23° C. (acrylic base), and Tesa® 7476 at 70° C. (rubber base).
Testing of tack instantaneous adhesion with no pressure) performance of the PSA after contact with the silicone coating in accordance with Finat Standard No. 9, Issue 5 of 1999.

VI. Results

TABLE 3

| COMPOSITIONS | 1 | 2 | 3 |
|---|---|---|---|
| Vinyl group containing | 40 | 40 | 40 |
| oil D | | | |
| Crosslinker E | 8.4 | 8.1 | 7.8 |
| FORMULATION-1 | 60 | | |
| FORMULATION-2 | | 60 | |
| FORMULATION-3 | | | 60 |
| Catalyst | 6.8 | 6.8 | 6.8 |
| % MD′Q in the | 0% | 2% | 4% |
| composition | | | |

4 days after crosslinking (“off-line”) force of
detachment g/cm

| | | | |
|---|---|---|---|
| Tesa ® 7475 23° C. | 14.5 | 19.5 | 20.5 |
| Tesa ® 7476 70° C. | 59.5 | 68 | 89 |
| (reversible peeling) | | | |

“Quick Tack” evaluations of PSAs after 20 hrs contact
on siliconized papers aged
2 months N/inch

| | | | |
|---|---|---|---|
| Tesa ® 4154 23° C. | 12.3 | 11.7 | 11.3 |
| Tesa ® 4651 23° C. | 16.2 | 14.5 | 16.0 |
| Tesa ® 4970 23° C. | 41.4 | 42.5 | 40.6 |
| Tesa ® 4154 70° C. | 12.8 | 13.1 | 15.5 |
| Tesa ® 4651 70° C. | 11.7 | 12.2 | 12.2 |
| Tesa ® 4970 70° C. | 40.7 | 39.8 | 39.9 |

Extractables (24 hrs in toluene) on papers aged 4
days

| | | |
|---|---|---|
| 2.5 | 4.2 | 5.9 |

It can clearly be seen that the resin B1=MD′Q increases the modulation levels with the two tesa® adhesives used 7475 and 7476. The levels of extractables are also slightly higher, the resin B1=MD′¹Q is not bonded to the network and is thus counted among the extractables. No impact on the tack of the pressure-sensitive adhesives “PSA” is seen

The extractables from the compositions 1 and 3 were analyzed by gas chromatography (GC)/infrared (IR) spectroscopy.

The attached FIGURE gives the curves obtained by GC with IR filtration corresponding to the siloxyl moieties Q (arbitrary units), in compositions 1 and 3, as a function of the GC times.

On inspection of the curves in the single FIGURE attached, it can be seen that composition 3 contains Q moieties in significant quantity (peak at ca. 0.60), whereas composition 1 contains practically none of them (peak at ca. 0.10).

This means that composition 3, which contains modulator (formulation 3) according to the invention, contains some extractable (nonreactive) POS-B resin MD′Q. The non-integration of the MD′Q resin in the base coating of crosslinked composition 3 is confirmed.

### Example 2

Study of a modulator containing a mixture of resin A1=MM^{Vi}Q/B1=MD′Q (90/10) with a competing modulator containing only a MM^{Vi}Q resin (ROTOMEC TRIAL. Tests with different proportions of modulator.

I. Formulation of the Modulators:

The formulation of the modulator according to the invention is as follows:
70% MQ resin (90% of A1=MM^{Vi}Q/10% of B1=MD′Q) see Example 1.
10% of diluent C3=α,ω-vinyl group containing oil containing 5.75 mmeq of vinyls/100 g.
20% of diluent C2=tetradecene.

The performance of the modulator according to the invention is compared with that of a commercial product containing only a resin A=MM^{Vi}Q (70% resin A=MM^{Vi}Q/12% of α,ω-vinyl group containing oil containing 5.75 mmeq of vinyls/100 g/18% of dodecene diluent).

These two modulators are formulated as described in Table 4 below, then coated onto Ahlstrom glassine 9564 paper using the Rotomec pilot coating plant.

TABLE 4

| Formulation | 4 | 5 | 6 | 7 | 8 | 9 | 10 |
|---|---|---|---|---|---|---|---|
| Vinyl group | 100 | 80 | 60 | 40 | 80 | 60 | 40 |
| containing | | | | | | | |
| oil D1 | | | | | | | |
| Crosslinker | 3.8 | 4.5 | 5.2 | 6 | 5.3 | 6.8 | 8.2 |
| E1 | | | | | | | |
| Pure | | 20 | 40 | 60 | | | |
| modulator A = | | | | | | | |
| MM^{Vi}Q | | | | | | | |
| Modulator | | | | | 20 | 40 | 60 |
| based on | | | | | | | |
| mixture | | | | | | | |
| A1 = MM^{Vi}Q/ | | | | | | | |
| B1 = MD′Q | | | | | | | |
| Catalyst | 6.8 | 6.8 | 6.8 | 6.8 | 6.8 | 6.8 | 6.8 |
| SiH/SiVi | 1.8 | 1.8 | 1.8 | 1.8 | 1.8 | 1.8 | 1.8 |

a vinyl group containing oil D1: α,ω-vinyl group containing oil with 0.022 mol/100 g of Vi, this oil contains 0.15% of ethynylcyclohexanol inhibitor ECH.
Crosslinker E1: a mixture of hydrogenated PDMS oils commonly referred to as cross-linker of MD′DM structure containing 1.33% of hydrogen and having a viscosity of 30 cps.
A Karstedt Pt catalyst containing 2000 ppm of Pt.
   II. Coating/Crosslinking Conditions:
   Speed: 100 m/min
   Oven: 150° C. to have 128° C. on the paper
   Deposition rate: 1.25-1.35 g/m²
   Substrate: Ahlstrom glassine 9564 (yellow)
   III. Coating Evaluation Tests:
Weight of the silicone coating: the silicon atoms in the coating are excited using a radioactive source or a fluo X tube and the X intensity reemitted by the coating is measured. By means of a calibration, the weight of the silicone coating is thus determined. The equipment used has reference number Lab X1000, marketed by the company Oxford.
Crosslinking: the polymerization level of the coating on exit from the coater is described by a certain number of specialist tests: “smear”, where the oily character of the surface is described and “rub off”, which characterizes the attachment to the substrate.
Force of detachment: the test used corresponds to the Finat Standards No. 3 and 10, Issue 5 of 1999. This test is performed 4 days after the crosslinking (“off-line”) with adhesive tapes marketed under the brand name Tesa® 7475 at 23° C. (acrylic base), and Tesa® 7476 at 70° C. (rubber base), and under the brand name BPS® 8170 (acrylic adhesive in solution).
Testing of tack (instantaneous adhesion with no pressure performance of the PSA after contact with the silicone coating in accordance with Finat Standard No. 9, Issue 5 of 1999.
   IV. Results:

Table 5 below summarizes the performance results obtained.

TABLE 5

| % modulator in the | | | | |
|---|---|---|---|---|
| crosslinkable | | | | |
| silicone composition | 0 | 20 | 40 | 60 |

Force of detachment g/cm “off-line” 4 days

| | | | | |
|---|---|---|---|---|
| Pure modulator A = | 6.25 | 9.1 | 32.85 | 115 |
| MM^{Vi}Q/Tesa ® | | | | |
| 7476/70° C. | | | | |
| Modulator based on | 6.25 | 19 | 52.2 | 106.5 |
| A1 = MM^{Vi}Q; | | | | |
| B1 = MD′Q/Tesa ® | | | | |
| 7476/70° C. | | | | |
| Pure modulator A = | 4.1 | 4.7 | 10.65 | 59.05 |
| MM^{Vi}Q/Tesa ® | | | | |
| 4651/23° C. | | | | |
| Modulator based on | 4.1 | 7.7 | 23.4 | 62.75 |
| A1 = MM^{Vi}Q; | | | | |
| B1 = MD′Q/Tesa ® | | | | |
| 4651/23° C. | | | | |
| Pure modulator A = | 5.6 | 7.7 | 13.9 | 41.8 |
| MM^{Vi}Q/Tesa ® | | | | |
| 4970/23° C. | | | | |
| Modulator based on | 5.6 | 8.1 | 16.6 | 47.4 |
| A1 = MM^{Vi}Q; | | | | |
| B1 = MD′Q/Tesa ® | | | | |
| 4970/23° C. | | | | |
| Modulator based on | 3.15 | 3.9 | 6.6 | 23.4 |
| A1 = MM^{Vi}Q; | | | | |
| B1 = MD′Q/Tesa ® | | | | |
| 7475/23° C. | | | | |
| Pure modulator A = | 3.15 | 4.2 | 8 | 21.5 |
| MM^{Vi}Q/Tesa ® | | | | |
| 7475/23° C. | | | | |
| Pure modulator A = | 4.6 | 7.45 | 14.15 | 33.9 |
| MM^{Vi}Q/BPS ® | | | | |
| 8170/23° C. | | | | |
| Modulator based on | 4.6 | 6.4 | 16.5 | 31.85 |
| A1 = MM^{Vi}Q; | | | | |
| B1 = MD′Q/BPS ® | | | | |
| 8170/23° C. | | | | |

“Quick Tack” N/inch “off-line” 4 days

| | | | | |
|---|---|---|---|---|
| Pure modulator A = | 23.2 | 22.1 | 23.2 | 23.4 |
| MM^{Vi}Q/Tesa ® | | | | |
| 4651/23° C. | | | | |
| Modulator based on | 23.2 | 22.4 | 21.6 | 21.3 |
| A1 = MM^{Vi}Q; | | | | |
| B1 = MD′Q/Tesa ® | | | | |
| 4651/23° C. | | | | |
| Pure modulator A = | 42.7 | 39.6 | 38.5 | 38.4 |
| MM^{Vi}Q/Tesa ® | | | | |
| 4970/23° C. | | | | |
| Modulator based on | 42.7 | 40.5 | 37.5 | 37.9 |
| A1 = MM^{Vi}Q; | | | | |
| B1 = MD′Q/Tesa ® | | | | |
| 4970/23° C. | | | | |
| CR Pure modulator A = | 34.7 | 34.6 | 36.2 | 32.7 |
| MM^{Vi}Q/Tesa ® | | | | |
| 7475/23° C. | | | | |
| Modulator based on | 34.7 | 35.8 | 32.2 | 33.4 |
| A1 = MM^{Vi}Q; | | | | |
| B1 = MD′Q/Tesa ® | | | | |
| 7475/23° C. | | | | |
| Pure modulator A = | 14.5 | 14.6 | 14.4 | 14.6 |
| MM^{Vi}Q/BPS ® | | | | |
| 8170/23° C. | | | | |
| Modulator based on | 14.5 | 14.4 | 14.4 | 15.5 |
| A1 = MM^{Vi}Q; | | | | |
| B1 = MD′Q/BPS ® | | | | |
| 8170/23° C. | | | | |

It can be seen that this resin mixture A1=MM^{Vi}Q; B1=MD′Q makes it possible to obtain a stronger modulating effect particularly at low modulator levels.

No impact on the tack of the PSA that have been in contact with the silicone coating is seen.

These resin mixtures are clearly more effective than a resin A=MM^{Vi}Q alone.

1. An adhesion modulator system based on:
(A) at least one polyorganosiloxane resin existing in solid form in the dry state, and consisting of at least two different types of siloxy moiety R₃SiO_{1/2} (moiety M) and SiO₂ (moiety Q) and/or RSiO_{3/2} (moiety T), and possibly moieties R₂SiO (moiety D), the radicals R being identical or different and representing organic radicals, with a number of moieties (M)/number of moieties (Q) and/or (T) ratio of 0.6-1, the number of moieties (D) that may be present being 0.5-10 per 100 mol of resin;
(B) at least one polyorganosiloxane resin existing in solid form in the dry state, and consisting of at least two different types of siloxy moiety R′₃SiO_{1/2} (moiety M) and SiO₂ (moiety Q) and/or R′SiO_{3/2} (moiety T), and possibly moieties R′₂SiO (moiety. D), the radicals R′ being similar or different and representing organic radicals, with a number of moieties (M)/number of moieties (Q) and/or (T) ratio of 0.6-1, the number of moieties (D) that may be present being 0.5-10 per 100 mol of resin;
(C) at least one solvent or at least one diluent of the mixture of resins (A) and (B);
characterized in that:
the resin (A) is reactive and represents a quantity in parts by weight, of 99 to 75, preferably 97 to 80, and still more preferably 96 to 85;
the resin (B) is nonreactive and represents a quantity in parts by weight, of 1 to 25, preferably 3 to 20 and still more preferably 4 to 15 parts by weight.

2. The adhesion modulator system as claimed in claim 1, characterized in that:
in the resin (A), the radicals R independently and at least partially represent:
alkyl—preferably C₁-C₁₈—, or (cyclo)alkyl preferably C₃-C₁₈— groups,
(cyclo)alkyl—preferably C₃-C₁₈— groups,
C₂-C₂₀, preferably C₂-C₁₂, alkenyl groups,
C₃-C₂₀, preferably C₄-C₁₂, (cyclo)alkenyl groups,
or (C₃-C₉)alkenyloxy(C₂-C₄)alkylene groups,
preferably at least 80 mol % of the radicals R representing a methyl group,
at least 0.1 mol %, preferably from 0.5 to 5 mol % of the radicals R representing an alkenyl or alkenyloxyalkylene group bound to silicon (“Si-alkenyl”), the vinyl radical (Vi) being particularly preferred as R=alkenyl;
in the resin (B), the radicals R′ independently and at least partially represent:
hydrogen,
alkyl—preferably C₁-C₁₈—, or (cyclo)alkyl preferably C₃-C₁₈— groups;
or (cyclo)alkyl—preferably C₁-C₁₈— groups,
preferably at least 80 mol % of the radicals R′ representing a methyl group;
the resin (A) containing less than 2.5 (preferably less than 0.5) mol % of silanol functions;
the resin (B) containing less than 10 (preferably less than 2.5) mol % of silanol functions.

3. The adhesion modulator system as claimed in claim 1 or 2, characterized in that the reactive resin (A) is a resin which contains Si-Vi moieties and which is selected from the group comprising:
MD^{Vi}Q where the vinyl groups are included in the moieties (D),
MD^{Vi}TQ where the vinyl groups are included in the moieties (D),
MM^{Vi}Q where the vinyl groups are included in part of the moieties (M),
MM^{Vi}TQ where the vinyl groups are included in part of the moieties (M),
MD^{Vi}T where the vinyl groups are included in the moieties (D),
MM^{hexenyl}Q (possibly containing moieties T bearing or not bearing an alkenyl group) where the hexenyl groups are included in part of the moieties (M),
MM^{allyloxypropyl}Q (possibly containing moieties T bearing or not bearing an alkenyl group) where the allyloxypropyl groups are included in part of the moieties (M),
all combinations of each of the aforesaid resins with moieties M^{OH} and/or D^{OH} and/or T^{OH},
and mixtures thereof.

4. The adhesion modulator system as claimed in any one of claims 1 to 3, characterized in that the nonreactive resin (B) is selected from the group comprising:
MD′Q where the hydrogen atoms bonded to silicon are included in the moieties (D),
MD′TQ where the hydrogen atoms bonded to silicon are included in the moieties (D),
MDD′Q where the hydrogen atoms bonded to silicon are included in the moieties (D),
MDD′TQ where the hydrogen atoms bonded to silicon are included in the moieties (D),
MDT′ where the hydrogen atoms bonded to silicon are included in the moieties (T),
MDD′T′ where the hydrogen atoms bonded to silicon are included in the moieties (T) and (D),
MDD′TT′ where the hydrogen atoms bonded to silicon are included in the moieties (T) and (D),
MQ,
MDQ,
MDTQ,
all combinations of each of the aforesaid resins with moieties M^{OH} and/or D^{OH} and/or T^{OH},
and mixtures thereof.

5. The adhesion modulator system as claimed in any one of claims 1 to 4, characterized in that the solvent or diluent (C) is selected from:
(1) standard hydrocarbon solvents for silicone resins, of the aromatic, or saturated aliphatic type, chlorinated solvents used in a quantity corresponding to 50-70 parts by weight per 30-50 parts by weight of solid resins (A)+(B);
(2) solvents described as “reactive” such as:
(a) liquid polyorganosiloxane resins, whereof the organic radicals are C₁-C₁₈ alkyl or cycloalkyl groups, C₂-C₂₀, preferably C₂-C₁₂, alkenyl groups, exhibiting a number of moieties (M)/number of moieties (Q) and/or (T) ratio of the order of 1 to 4 and possibly from 1 to 5 moieties (D) per 100 mol of liquid resin, and containing from 0.5 to 5 mol % of alkenyl functions bonded to silicon (“Si alkenyl”) or atoms of hydrogen bonded to silicon (“SiH”), these resins exhibiting a viscosity at 25° C. of less than 100 mPa.sec, preferably of the order of 2 to 50 mPa.sec:
and/or (b) liquid polyorganosiloxane oils, whereof the organic radicals are C₁-C₁₈ alkyl or cycloalkyl groups, C₂-C₂₀ alkenyl, (C₃-C₉)alkenyloxy(C₂-C₄)alkylene, oils containing from 0.2 to 5 mol % of alkenyl or alkenyloxyalkylene groups bonded to silicon, as chain end(s) or within the chain, said oils exhibiting a viscosity of less than 200 mPa.sec;
and/or (b′) liquid polyorganosiloxane oils, bearing hydrogen substitutents and whereof the organic radicals are C₁-C₁₈ alkyl or cycloalkyl groups, C₂-C₂₀ alkenyl, (C₃-C₉) alkenyloxy(C₂-C₄)alkylene, oils containing from 0.2 to 5 mol % of hydrogen substitutents bonded to silicon, as chain end(s) or within the chain, said oils exhibiting a viscosity of less than 200 mPa.sec;
and/or (c) hydrocarbons with one or more olefinically unsatured groups(s) such as C₁₄-C₁₈ olefins, dibutyl maleate, decyl vinyl ether, dodecyl vinyl ether, camphene, meta-bis-isopropenylbenzene;
said solvents described as “reactive” being generally used in a quantity corresponding to 20-50 parts by weight per 80-50 parts by weight of solid resins (A)+(B);
(3) aqueous emulsions of nonionic surfactants containing of the order of 1-3% by weight of surfactant, used in a proportion of 40-70 parts by weight per 60-30 parts by weight of solid resins (A)+(B).

6. A curable anti-adhesive composition containing:
at least one linear polydiorganosiloxane (D) blocked by terminal triorganosiloxane groups, said organic radicals being C₁-C₁₈ alkyl or cycloalkyl groups, C₂-C₂₀, preferably C₂-C₁₂, alkenyl, (C₃-C₉)alkenyloxy(C₂-C₄)alkylene, at least 80 mol % of said radicals being a methyl group, at least 0.1 mol %, preferably from 0.5 to 5 mol % of said organic radicals being identical or different alkenyl or alkenyloxyalkylene groups directly bonded to silicon (“Si alkenyl”);
at least one modulator system based on the constituents (A), (B) and (C) as defined above;
at least one hydrosilylation inhibiting agent;
at least one linear polyorganohydrogensiloxane crosslinking agent (E) containing from 1.6 to 0.5 mol % of hydrogen atoms directly bonded to silicon (“SiH”) as chain end(s) and/or within the chain, the identical or different organic radicals being C₁-C₁₈ alkyl groups, at least 80 mol % of said organic radicals being methyl groups, the quantity of crosslinking agent being such that the (number of moles of “SiH” deriving from the nonreactive resin (B), from the “reactive” solvent (C) and from the crosslinking agent (E))/(number of moles of “Si alkenyl” deriving from the reactive resin (B), from the “reactive” solvent (C) and from the linear blocked polydiorganosiloxane (D)) ratio is greater than 1, preferably of the order of 1.1 to 2.5;
an effective quantity of a hydrosilylation catalyst.

7. The compositions as claimed in claim 6, characterized in that the concentration of [POS (B)], in % dry weight relative to the total mass of the composition is defined as follows:
[POS (B)]≦20
preferably [POS (B)]≦15
and still more preferably [POS (B)]≦10.

8. The compositions as claimed in claim 6 or 7, characterized in that the linear blocked polydiorganosiloxane with “Si-alkenyl” functions (D) exhibits a viscosity of the order of 100 to 1000 mPa.sec.

9. Compositions according to any one of claims 6 to 8, characterized in that the crosslinking agent with “Si—H” functions (E) exhibits a viscosity of the order of 5 to 150 mPa.sec.
